(19) United States
(12) Patent Application Publication
(10) Pub. No.: US 2011/0212326 A1
(43) Pub. Date: Sep. 1, 2011

(54) METHOD FOR COATING SURFACES WITH PARTICLES AND USE OF THE COATINGS PRODUCED BY THIS METHOD

(76) Inventors: Cindy Ettrich, Frankfurt/Main (DE); Michael Schwamb, Frankfurt (DE); Daniel Wasserfallen, Mainz (DE)

(21) Appl. No.: 13/128,005

(22) PCT Filed: Nov. 6, 2009
(86) PCT No.: PCT/EP09/64741

§ 371 Date: May 6, 2011

(30) Foreign Application Priority Data
Nov. 12, 2008 (DE) 10 2008 043 682.8

(51) Int. Cl. B32B 3/00; B05D 1/36

(52) U.S. Cl. 428/335; 427/470

(57) ABSTRACT

A method for the electroless coating of surfaces of articles and particles with a multiplicity of inorganic and organic water-insoluble particles to form a substantially flush-resistant layer of high particle density, in which the particles are applied to the surfaces to be coated in an aqueous composition that can be stabilized or is stable, in the form of a dispersion, and are applied to the surface to be coated substantially or predominantly by electrostatic forces and are applied to and secured on the surfaces to be coated substantially or predominantly by electrostatic forces. The surface to be coated are first activated by an activating agent, wherein an activation layer with charges is formed by the activating agent on the surfaces to be coated.

The invention relates to a process for coating, in particular, metallic surfaces with particles to achieve a high particle density, a corresponding coating and the use of the coatings produced by this process.

Many processes are known with which particles can be applied via liquid systems to, in particular, metallic surfaces. Most processes have the disadvantage that the techniques used are often comparatively involved and expensive in order to achieve a relatively high particle density in comparatively thick organic or substantially organic coatings. The higher the content of solids and active substances in the liquid composition, the greater the problems which may occur in order to deposit a relatively high particle density, in particular in the form of defined layers from thin layers, in particular of monolayers or layers with a thickness of several particle diameters, as a particle layer on the, in particular, metallic surface and to produce correspondingly closed coatings therefrom.

In currently conventional industrial practice, this problem is solved by the use of cathodic dip-coatings (CDC), in which a relatively thick covering layer is deposited on the substrate with the aid of electric fields and correspondingly adapted lacquer formulations.

This technique has the disadvantage that in addition to the necessary amount of electrical energy and in addition to suitable dipping basins, which lead to an increase in costs, so-called edge-thinnings also occur, since electric fields are built up inhomogeneously on macroscopic edges and the edges are coated non-uniformly and possibly also incompletely. Furthermore, coating of cavities is scarcely possible or even impossible because of the wrap-around problems due to the lack of electric field strengths, and requires a high outlay in order to avoid these cavities and to produce a closed layer.

For example, this technique has the following disadvantages in an electrical dip-coating (EDC), such as e.g. in cathodic dip-coating (CDC): A corresponding dipping bath, together with all the electrical and mechanical equipment from temperature control, current supply and electrical insulation, circulation equipment and addition equipment, to disposal of the anolyte acid formed during the electrolytic coating, and with an ultrafiltration to lacquer recycling as well as control equipment, is very expensive in construction. The process control requires a very high technical outlay also because of the high current strengths and amounts of energy and in the homogenizing of the electrical parameters over the bath volume and in the precise adjustment of all process parameters as well as in the maintenance and cleaning of the installation.

It is a long-pursued desire to form homogeneous coatings from or with a high number of particles and with a high particle density efficiently and inexpensively, in order to produce as far as possible closed and substantially flat coatings therefrom. If organic particles are used, these can form a film in many embodiments. In the case of inorganic particles, such as e.g. in the case of titanium dioxide or in the case of aluminium oxide, the maximum possible functionalization of an, in particular, metallic surface is often achieved with this technique. It is often appropriate here to employ nanoparticles or/and particularly fine particles.

If organic particles are to be deposited from a dispersion on to a metallic surface, this usually has the disadvantage that rheological auxiliary substances, such as e.g.

wetting agents or/and film-forming auxiliary substances, are necessary as an addition to the dispersion in order to apply a dry film which is as uniformly thick as possible over comparatively rough surfaces. During drying or/and film formation, defects may occur here, as shown schematically in cross-section in FIG. 1A. On industrial surfaces which are rough in the micro range, conventionally no self-regulating, area-covering, closed and homogeneous distributions occur over corners, edges and depressions, but the film-forming material can collect in the depressions (see FIG. 1A), such as e.g. in the currentless application in a coil coating process, e.g. by knife coating. This has meant that in many uses, such as e.g. in coil coating processes, the depressions in the micro range are filled up, while the coating thickness at the edges and peaks is minimal and some edges and peaks even project out of the coating (see FIG. 1A).

If inorganic particles are deposited in a strong electric field with an externally applied voltage, this conventionally has the disadvantage that the particles are preferentially deposited at places with a high electric field strength, which leads to non-uniform layer thicknesses and distributions. These irregularities in the micrometre range are no longer so conspicuous in electrophoretic dipping processes due to the high layer thicknesses of the order of about 20 μm (FIG. 1B).

FIG. 1C reproduces, schematically in cross-section, the dry film of the process according to the invention of the organic or substantially organic coating on the, in particular, metallic substrate, ignoring at least one pretreatment step and optionally also at least one further coating, such as e.g. a coloured lacquer layer.

If it were possible to apply a completely covering and as far as possible homogeneous coating, this could perhaps be significantly thinner, without losing the otherwise good properties of a comparable coating according to the prior art.

There is therefore the object of proposing a process with which a high number of particles can be deposited in a simple manner homogeneously, in an area-covering manner and with a high particle density via a liquid system in a currentless manner and if required also in a wash-resistant manner on, in particular, metallic surfaces. There was furthermore the object of proposing a multistage process for this which is as simple as possible.

The object is achieved with a process for the currentless coating of, in particular, metallic surfaces of objects or/and particles, which can optionally be precoated (=surfaces to be coated), with a large number of inorganic water-insoluble or/and organic water-insoluble particles to form a substantially wash-resistant layer having a high particle density, in which the particles are applied to the surfaces to be coated in a stabilizable or stable aqueous composition in the form of a dispersion (=suspension or/and emulsion) and are applied to and held on the surfaces to be coated substantially or predominantly by means of electrostatic forces, characterized in that

the surfaces to be coated are first activated with an activating agent, wherein an activation layer with charges is formed with the activating agent on the surfaces to be coated, wherein these charges are charged oppositely to the charges of the particles of the composition which are subsequently to be applied,

in that the particles applied in a coating step with a particle-containing composition are charged oppositely to the charges of the activation layer,

in that in a or in each coating step with a particle-containing composition in each case a layer is formed on the surfaces to be coated in an average thickness of approximately one or more average particle sizes of the particles applied and the or each particle layer is optionally then formed into a film or/and crosslinked, as a result of which a layer thickness of the or each particle layer of particles not formed into a film, or/and of the coating(s) formed into a film or/and crosslinked, produced therefrom, in each case in the range of from 5 nm to 50 μm is achieved.

Preferably, the particles are applied to the surfaces to be coated with a stabilizable or stable aqueous composition in the form of a dispersion (=suspension or/and emulsion) by means of electrostatic forces of attraction. Preferably, the particles which have been applied using a stabilizable or stable aqueous composition in the form of a dispersion (=suspension or/and emulsion), in particular electrostatically, are then held on the surfaces electrostatically or electrostatically and with van der Waals forces, covalent bonds or/and complexing reactions.

Preferably, in the process according to the invention, in the one or in each coating step with a particle-containing composition, regardless of the subsequent continuation of this coating step, in each case a layer is formed on the surfaces to be coated in an average thickness of approximately one or more average particle sizes of the particles applied.

Preferably, in the case of at least a second electrostatic coating step with a particle-containing composition the particles are charged oppositely to the charges of the particular previously applied layer of particles. If several particle layers are formed on top of one another from particle-containing compositions, these layers are built up preferably alternately from particles which are positively charged with protons or/and cations and from particles which are negatively charged with anions.

The objects or/and particles to be coated can be those of any desired material. Preferably, the objects or/and particles have surfaces of metal, alloy, plastic, composite material, natural material, glass or/and ceramic. Any conventional metallic objects which are to be protected from corrosion can also serve as the objects. However, in principle they can be all objects of in each case at least one plastic, composite material, natural material, glass, ceramic or/and metallic material which are optionally already coated and are now to be coated. For example, elements of plastic for vehicle bodies, bumpers, apparatuses and buildings can be coated in the manner according to the invention. The same as for objects also applies to particles, coated particles being produced. This applies in particular to larger particles and to compounded particles.

The term “currentless coating” in the context of this application means that during coating with the particle-containing composition no electrical voltage is applied externally, which considerably impairs the application of the particles of the composition due to electrostatic attraction.

The term “surface(s) to be coated” in the context of this application means in particular metallic surfaces of, in particular, metallic objects or/and of, in particular, metallic particles, which can optionally be precoated, e.g. with a metallic coating, such as e.g. based on zinc or zinc alloy or/and with at least one coating of a pretreatment or treatment composition, such as e.g. based on chromate, Cr³⁺, Ti compound, Zr compound, silane/silanol/siloxane/polysiloxane or/and organic polymer.

The term “polymer(s)” in the context of this application means monomer(s), oligomer(s), polymer(s), copolymer(s), block copolymer(s), graft copolymer(s), mixtures thereof and compoundings thereof on an organic or/and substantially organic basis. The “polymer(s)” in the context of this application is/are conventionally predominantly or entirely in the form of polymer(s) or/and copolymer(s).

The term “pretreatment” means a treatment (=contacting of the surfaces to be coated with a conventionally liquid composition) in which, optionally after a subsequent coating, a further coating is subsequently applied to protect the layer sequence and the object, such as e.g. at least one lacquer.

The term “treatment” or “passivation” means a contacting of the surfaces to be coated with a conventionally liquid composition in which, for a certain period of time or in the long term, no further protective coating, such as e.g. at least one lacquer layer, is subsequently applied. In this context, for example, an oil, an oil-containing composition or a passivating composition, such as e.g. with a content of at least one titanium and/or zirconium compound, can be applied. If these surfaces are later to be provided permanently with high-quality protection, these coatings of the treatment or passivation are often first to be removed. In certain process stages the term “treatment” can moreover in some cases also mean a contacting and, for example, cleaning, pickling and/or coating, regardless of the abovementioned definition.

The term “substantially wash-resistant” in the context of this application means that under the conditions of the particular installation and process sequence the particular last coating, such as e.g. a) an activation layer or/and b) a particle layer is not completely removed by a washing operation (=washing) and therefore in the case of a) its activating action for the electrostatic coating with the particles subsequently to be applied or in the case of b) a coating produced from particles is not completely removed, so that a coating, preferably a closed coating, can be produced from the particle layer.

The term “water-insoluble particles” in the context of this application means that the water-solubility of the particles is so low that no or only minimal passage of the individual constituents of the particles into the aqueous phase occurs. These water-insoluble particles also include stabilized particles in which the stabilization takes place or/and is present in the aqueous phase and preferably can be achieved with at least one nonionic or/and ionic emulsifier, and optionally with at least one flow control agent or/and with at least one thickening agent.

The term “electrically conductive particles” in the case of the particle-containing composition in the context of this application means that the electrical conductivity of the particles is so low that no substantial impairment of the electrical attraction of opposite charges occurs between the activation layer and particles or between the particles of various particle layers on top of one another.

In the process according to the invention, there are two basic process variants.

In the process according to the invention, it is preferable to form an activation layer on the surface to be coated, which in process variant A) in the case of a cationic activation layer is produced by contacting with at least one cationic compound, and which in process variant B) in the case of an anionic activation layer is produced by contacting with at least one anionic compound.

In the process according to the invention, it is preferable for at least one protonatable or/and protonated silane or/and at least one protonatable or/and protonated, in particular nitrogen-containing compound to be used as the cationic compound(s) or for at least one deprotonatable compound or/and at least one deprotonated anion or/and at least one deprotonatable or/and deprotonated (=anionic) compound to be used as the anionic compound(s).

Either in process variant A) the activation layer is positively charged (=positive charging) with protons or/and cations, such as e.g. with at least one cation of at least one quaternary ammonium compound or/and with at least one acid, and the first particle layer of a particle-containing composition applied thereto is correspondingly negatively charged with anions, in particular anionic groups, such as e.g. carboxylate groups or/and hydroxide groups—or, conversely, in process variant B) the activation layer is negatively charged (=negative charging) with anionic groups and the first layer of particles of a composition applied thereto is positively charged with protons or/and with cations. In the context of this application, anionic compounds are also called anions.

If several layers, in particular 2, 3, 4 or 5 layers, are formed on top of one another from particles of compositions containing in each case or alternately different particles, these are layers preferably alternately of particles which are positively charged with protons (H⁺) or/and with cations and of particles which are negatively charged due to anionic groups, such as e.g. carboxylate groups or hydroxide groups. The term “protons or/and cations” here also includes compounds with functional groups, such as e.g. quaternary ammonium groups and complexing agents.

The activation or/and the intensification of the activation serves/serve to charge the surfaces with many electrical charges. If cationically charged activating agents are applied to the surfaces, the particles to be applied thereafter must be anionically charged in order to be correspondingly attracted and anchored. If anionically charged activating agents are applied to the surfaces, the particles to be applied thereafter must be cationically charged in order to be correspondingly attracted and anchored. The higher the charge of the activation layer or of the particles, the more particles and the more adhesively can the particles of the next layer be applied thereto. These particle layers are then conventionally also all the more wash-resistant.

In the process according to the invention, the activating agent, the activation layer, the particle-containing composition or/and the particles can be electrically positively or negatively charged as required. They correspondingly have a cationic or anionic action.

Particularly preferably, the activation layer or the particles of the last particle layer is/are charged in particular with a positively or negatively chargeable or/and positively or negatively charged liquid or/and with positive or negative electrical charges of a gas or in vacuo (=positive or negative charging). The same applies accordingly to the intensification of a positively or negatively charged activation layer or the particles of the last particle layer.

Cationic activating agents contain at least one cationic substance, anionic activating agents contain at least one anionic substance.

In particular, a cationic activation layer or/and cationically charged particles can additionally be electrically positively charged more strongly e.g. with or/and in an acid aqueous liquid, such as e.g. a solution or dispersion. This is preferably effected at a pH in the range of from 1 to 7.5, particularly preferably at a pH in the range of from 1.5 to 7, from 2.5 to 6 or from 3.5 to 5, e.g. with a solution or dispersion containing aqueous acid or/and cations.

In particular, an anionic activation layer or/and anionically charged particles can additionally be electrically negatively charged more strongly with or/and in a basic aqueous liquid, such as e.g. a solution or dispersion. This is preferably effected with an aqueous liquid at a pH in the range of from 7 to 14, particularly preferably at a pH in the range of from 8.5 to 13, from 9.5 to 12 or from 10 to 11, e.g. with an aqueous hydroxide-containing solution or dispersion.

The positive charging of an activating agent, an activation layer, a particle-containing composition or/and of particles can preferably be effected by treatment with ionized gas, by acid pickling with a pickling fluid (gas, solution, dispersion or/and paste), treatment with a liquid carrying protons or/and cations or/and by a treatment e.g. with at least one acid for positive charging. A positive charging by aqueous solution of acids or with reactive solutions of substances, such as e.g. in the case of quaternary ammonium compounds, which carry cationic groups is particularly preferred.

In the process according to the invention, the positive charging of an activation layer or of particles of the particle layer is preferably effected by treatment with at least one acid or/and with at least one substance which carries cationic groups, or the negative charging of an activation layer or of particles of the particle layer is preferably effected by treatment with at least one anion or/and with at least one substance which carries anionic groups.

In the process according to the invention, the production and activation of the cationic activation layer or the contacting and activation of particles of the particle layer is preferably effected with at least one cationic silicon compound or/and the positive charging of the activation layer or of particles of the particle layer is preferably effected by treatment with at least one acid or/and with cationic groups.

In the process according to the invention, the most diverse substances can be used as electrostatically active substances of an activating agent.

Preferably, for a positive activation or/and for a positive charging additionally at least one treatment with protons, in particular from at least one acid, or/and with cations, such as e.g. from metal cations or/and ammonium ions, including cationic compounds, such as e.g. from at least one quaternary ammonium compound, from at least one complexing agent, such as e.g. the haem complex (Fe²⁺), or/and from at least one water-soluble cationic silicon-containing compound, such as e.g. at least one silane/silanol/siloxane/polysiloxane/silazane/polysilazane, in particular with in each case at least one nitrogen-containing group, is used.

For cationic activating agents, compounds with at least one nitrogen-containing group or/and acids are suitable. For cationic activating agents, for example, the content of at least one cationic substance has proved appropriate, such as e.g. at least one silane or/and at least one compound which differs/differ from this, which contains at least one nitrogen-containing group, such as e.g. amino, imino, amido or/and imido group. Many ammonium compounds or/and acids are moreover also advantageous.

Coating with an activating agent which contains e.g. at least one protonated compound, such as e.g. at least one protonated silane, functionalizes the surface and gives it a positive charge.

In the process according to the invention, the production and activation of the anionic activation layer or the contacting and activation of particles of the particle layer is preferably effected with at least one anionic compound or/and the negative charging of the activation layer or of particles of the particle layer is preferably effected by treatment with at least one anion or/and with at least one anionic compound.

Suitable anionic substances in anionic activating agents for negative charging or/and for its intensification here are, in particular, a) substances with groups of borate, carbonate, carboxylate, halide, such as e.g. chloride or/and fluoride, hydroxide, phosphate, phosphonate, sulfate or/and sulfonate, b) negatively charged complexes or/and esters thereof. Among the carboxylate groups, carboxylate groups of any desired carboxylic acids are possible. For anionic activating agents, for example, the content of at least one anionic organic polymer has proved appropriate, such as e.g. based on polyacrylic acid, polyphosphonic acid, polyvinylphosphoric acid, polyvinylphosphoric acid esters or/and derivatives thereof.

The negative charging of an activating agent, an activation layer, a particle-containing composition or/and of particles of the last particle layer can preferably be effected by irradiation with beta radiation (electrons), by treatment with ionized gas, by contacting with a liquid, such as e.g. with an alkaline cleaner liquid, with an alkaline pickle or/and by a pretreatment with at least one negatively charged substance. Negative charging with anions is particularly preferred, and in particular by anion-carrying aqueous solutions, such as e.g. solutions with at least one metal hydroxide, such as e.g. sodium hydroxide, potassium hydroxide, or/and with an organic alkali metal compound. A solution, a dispersion or/and a gas with at least one basic substance, such as e.g. with at least one anionic activating agent, in particular with an alkali, e.g. based on KOH or/and NaOH, or/and e.g. with in each case at least one phosphonate, phosphoric acid ester and/or sulfonate, is/are particularly preferred here.

The positive or negative charging can be intensified if the charged activation layer or the charged particles of the last particle layer comes/come into contact with at least one correspondingly charged substance, which leads to an even stronger positive or negative charge.

Particularly preferably, the surfaces to be coated, the particles of the particle-containing composition or the particles of the last particle layer are negatively charged in particular with a negatively charged or/and negatively chargeable liquid or/and with ionized charges, in particular in an alkaline aqueous liquid. The same applies accordingly to the intensification of a negative charge.

The negative charging of an activating agent, an activation layer, a particle-containing composition or/and of particles can be intensified if, preferably, additionally at least one treatment is carried out after the functionalization of the surface with the same charges as have already been applied, preferably by additionally carrying out at least one alkaline treatment with ionized gas, with a cleaner liquid or/and by alkaline pickling. An additional negative charging with an aqueous solution of at least one metal hydroxide, such as e.g. sodium or/and potassium hydroxide, is particularly preferred.

The at least one activating or/and activatable substance can be contained in the activating agent or in a liquid for negative charging preferably in a concentration in the range of from 0.01 to 200 g/l, from 0.1 to 120 g/l, from 0.5 to 70 g/l, from 1 to 30 g/l or from 2 to 10 g/l. It is often the case that the at least one substance which is active here is simultaneously partly activated and can be activated some more.

It is particularly advantageous or/and particularly suitable for certain industrial process sequences and installations if a substantially wash-resistant activation layer is formed.

In the process according to the invention, a substantially wash-resistant activation layer is preferably formed with the at least one activating or/and activatable substance in the activating agent.

It is particularly advantageous or/and particularly suitable for certain industrial process sequences and installations if a or if in each case a substantially wash-resistant layer of particles is formed.

Since a liquid agent, such as e.g. an activating agent or such as e.g. a particle-containing composition, may possibly not flow off completely after the coating in depressions in substrates of complex shape which are to be coated, such as e.g. vehicle bodies in automobile construction, without a subsequent washing step, e.g. with a water wash, an accumulation of the activating agent and excessively thick coatings in these depressions and speckles may occur, leading to irregularities and lacquer defects. The substrates coated with an activating agent or/and with a particle-containing composition are therefore preferably washed. Deionized water is used in particular here. During the washing of the substrates coated with activating agent, the activation layer or the particle layer should be removed as little as possible and must not be removed completely. The activation layer or the particle layer must therefore be sufficiently wash-resistant for such installations and process sequences.

Since in a washing operation a part of the fresh coating is often washed off, it is advantageous to check the residual contents in the activation layer e.g. of elements by x-ray fluorescence analysis (XRFA). It proved to be advantageous if the highest possible content of the activation layer remained during the washing, since in some embodiments the deposition density and the speed of deposition improve approximately in proportion to the thickness of the activation layer.

In the process according to the invention, washing of the activation layer or/and of the particle layer can preferably be carried out with a flowing or/and in a streaming aqueous wash liquid, e.g. by spraying down, spray washing or/and dip washing. The washing can be carried out in particular as dip washing, in particular by dipping in an agitated bath, as spray washing, e.g. by spraying on to the surface to be washed, and/or by washing down the surface to be washed. In each washing the washing can be carried out several times as required, e.g. at least once with deionized water, thereafter at least once with a less highly purified water quality or/and with a rinsing liquid.

The residual contents in the activation layer which are obtained after washing with, in particular, deionized water illustrate that in spite of intensive washing sufficiently high contents of the activation layer are conventionally retained. These contents are sufficient to actively prepare the activated surface for the subsequent treatment steps.

In the application of a cationic or anionic activating agent, in many embodiments it may be advantageous to ensure that the coating formed is substantially wash-resistant. In the case of an anionic activating agent it is moreover often to be ensured that the coating is also applied uniformly or/and that the activating agent applied is stable to hydrolysis.

As particularly preferred substances for a cationic activating agent, the use of at least one, of at least two or of at least three different silanes has proved to be advantageous. They make possible not only an increased corrosion protection and an increased adhesion of the subsequent layer or coating, but also a good charging with protons and/or cations. Cationic activating agents have furthermore proved to be particularly appropriate in particular for homogeneous particle distributions of the particles subsequently deposited.

The term “silane” is used here for silanes, silanols, siloxanes, polysiloxanes, reaction products or/and derivatives thereof, which in this context are also often “silane mixtures”. Because of the diverse chemical reactions, a large number of reaction products and derivatives thereof can be formed from one, from two, three, four, five or more silanes. The term “condensing” in the context of this application designates all forms of crosslinking, further crosslinking and further chemical reactions of the silanes/silanols/siloxanes/ polysiloxanes.

The term “activation layer” in the context of this application relates to the coating formed with the aqueous activating agent, including the wet film, the superficially dried film, the completely dried film, the film dried at elevated temperature and the film optionally further crosslinked by heat or/and by irradiation.

The at least one activating substance and in particular the at least one silane in a cationic activating agent can be contained in the cationic or anionic activating agent preferably in a concentration in the range of from 0.01 to 100 g/l, from 0.1 to 70 g/l, from 0.5 to 40 g/l; from 1 to 25 g/l, from 1.5 to 12 g/l or from 2 to 6 g/l.

In the process according to the invention, preferably at least one hydrolysable or/and at least one at least partly hydrolysed silane can be present as a silicon compound. Preferably at least one mono-silyl-silane, at least one bis-silyl-silane or/and at least one tris-silyl-silane can be present. Silanes which are present in protonated form in the acid medium (cationic silane) are preferred here in particular. Preferably at least one aminosilane, at least one silane with at least two nitrogen-containing groups, such as e.g. in each case at least one amido group, amino group, urea group, imido group or/and imino group, or/and a mixture of at least two different silanes protonated in the acid medium can be present. In particular those silanes/siloxanes which have a chain length in the range of from 2 to 5 C atoms and a functional group, wherein the latter can preferably be suitable for reaction with polymers, and branched silanes are preferred in this context.

The aqueous activating agent preferably contains at least one silane chosen from the group of

aminoalkylaminoalkylalkyldialkoxysilane,

alpha-aminoalkyliminoalkyltrialkoxysilane,

bis-(trialkoxysilylalkyl)amine,

bis-(trialkoxysilyl)ethane,

aminoalkyltrialkoxysilane,

ureidoalkyltrialkoxysilane,

N-(trialkoxysilylalky)alkylenediamine,

N-(aminoalkyl)aminoalkyltrialkoxysilane,

N-(trialkoxysilylalkyl)dialkylenetriamine,

poly(aminoalkyl)alkyldialkoxysilane and

ureidoalkyltrialkoxysilane.

The aqueous activating agent preferably contains at least one silane chosen from the group of

alpha-aminoethyliminopropyltrimethoxysilane,

aminoethylaminopropylmethyldiethoxysilane,

aminoethylaminopropylmethyldimethoxysilane,

bis(triethoxysilylpropyl)amine,

bis(trimethoxysilylpropyl)amine,

gamma-aminopropyltriethoxysilane,

gamma-aminopropyltrimethoxysilane,

gamma-ureidopropyltrialkoxysilane,

N-(3-(trimethoxysilyl)propyl)ethylenediamine,

N-beta-(aminoethyl)-gamma-aminopropyltriethoxysilane,

N-beta-(aminoethyl)-gamma-aminopropyltrimethoxysilane,

N-(gamma-triethoxysilylpropyl)diethylenetriamine,

N-(gamma-trimethoxysilylpropyl)diethylenetriamine,

N-(gamma-triethoxysilylpropyl)dimethylenetriamine,

N-(gamma-trimethoxysilylpropyl)dimethylenetriamine,

poly(aminoalkyl)ethyldialkoxysilane and

poly(aminoalkyl)methyldialkoxysilane.

Particularly preferred silicon compounds are bis(3-trimethoxysilylpropyl)amine, bis(3-triethoxysilylpropyl)amine, 3-aminopropyltriethoxysilane, bis-(triethoxysilyl)ethane, phenylaminopropyltrimethoxysilane and triamino-organofunctional silane, such as e.g. 3,5,7-triamino-trimethoxysilane.

Contents of at least one acid and at least one cationic silane are particularly preferred. In particularly preferred embodiments, the aqueous activating agent containing silane/silanol/siloxane/polysiloxane contains a) at least one compound chosen from silanes, silanols, siloxanes and polysiloxanes, b) at least one titanium-, hafnium- or/and zirconium-containing compound, optionally c) at least one type of cations chosen from cations of metals of sub-group 1 to 3 and 5 to 8, including lanthanides, and of main group 2 of the periodic table of the elements or/and at least one corresponding compound and optionally at least one substance d) chosen from: d₁) silicon-free compounds with at least one nitrogen-containing group, such as e.g. with in each case at least one amino, urea or/and imino group or/and several amino groups or/and with at least one nitro group, d₂) anions of nitrite, d₃) compounds based on peroxide and d₄) phosphorus-containing compounds, anions of at least one phosphate or/and anions of at least one phosphonate and furthermore e) water and f) optionally also at least one organic solvent. Preferably, in some embodiments the activating agent can moreover also contain in each case at least one organic polymer, at least one amine, at least one base, at least one complexing agent, at least one surfactant, at least one type of inorganic particles, at least one dyestuff, at least one additive or/and in each case at least one inorganic or/and organic acid or/and at least one of its derivatives.

In preliminary experiments, it had proved advantageous if the freshly applied and not yet dried or still incompletely dried, still incompletely condensed or/and still incompletely crosslinked activation layer is washed at least once, in particular with deionized water, or/and is coated directly, without more intense drying, with an organic or substantially organic coating. This resulted in significantly better reactivities and significantly better layer properties. The washing can be carried out in particular as dip washing, in particular in an agitated bath, or as spray washing, e.g. by spraying, During the washing, excess coating which is not firmly bonded can be washed off.

In the process according to the invention, it is preferable, after an activation of the, in particular, metallic surface with at least one water-soluble silicon-containing compound, before or/and after the coating with the particle-containing composition and optionally after at least one washing with a wash liquid, such as e.g. water, for a deposit of the corresponding silicon-containing compound with an Si deposit, calculated as metal, in the range of from 2 to 100 mg/m² still to be detectable in an x-ray fluorescence analysis.

If an activating agent has functionalities, the functionalities can be even more strongly positively charged, for example by an acid treatment, in order to make possible a higher and as far as possible complete charging with protons and/or cations. Thus, for example, the amine functionalities of silanes of the previously applied activation layer can be more strongly positively charged by the acid treatment. This acid treatment furthermore makes possible the use of silanes in the activating agent in a pH range suitable for the silanes used. Scanning-electron-microscope photographs showed a significantly denser and more uniform deposition of particles in the particle layer when the activation layer was positively charged beforehand, for example by an acid treatment.

Conversely, it is likewise possible for an anionic activation layer to be even more strongly negatively charged by, for example, alkaline treatment. On anionically charged surfaces, the functionalities in particular of the washed anionically charged activation layer can be charged, if required, by treatment with a basic activating agent for even stronger negative charging, such as e.g. ammonia, so that e.g. via formation of NH₄⁺ e.g. COOH becomes COO⁻.

Thereafter, the correspondingly positively or negatively charged surfaces can be washed, e.g. with deionized water, in order to remove excess acid or cationic substance or excess alkaline agent and optionally other substances and impurities.

Thereafter, a particle layer is applied to the anionic or cationic activation layer, optionally after a subsequent negative charging or positive charging. The particles here are preferably contained in an aqueous dispersion, in particular in a stable dispersion. In addition to water, this composition can optionally also contain at least one organic solvent which does not or does not substantially superficially dissolve the particles. The particles here are applied to the activation layer from the aqueous composition, preferably predominantly or only on the basis of electrostatic attraction, and are then held on this either electrostatically or/and with a large number of interactions, such as e.g. van der Waals forces, formation of covalent bonds or/and complexing reactions.

In the process according to the invention, the most diverse types of particles, particle sizes and particle forms can be used as particles of the particle-containing composition.

Preferably, the particles of the composition have an average particle size d₅₀ in the range of from 10 nm to 45 μm. The particle size can be varied within wide limits according to the profile of requirements. The average particle size d₅₀ will often be in the range of from 20 nm to 100 nm, from 50 nm to 180 nm, from 0.1 to 10 μm or/and from 5 to 30 μm. It may be advantageous here to choose an average particle size of the particles in a manner such that a coating of the desired layer thickness can be formed from an individual layer. Even if the particles are relatively large, with suitable stabilization it is possible, where appropriate with greater expenditure, both to keep these particles suspended in a dispersion and to charge them electrostatically and to deposit them on a substrate by means of electrostatic forces, preferably without an applied external electric field. In the case of small particles sizes in particular, in some embodiments the particles of the composition have substantially the same diameter and/or substantially spherical shapes.

The particles can be present in the composition particularly preferably in a concentration in the range of from 0.1 to 500 g/l, from 1 to 250 g/l, from 5 to 120 g/l or from 10 to 60 g/l. In particular if the particle diameters of the particles of the composition are present in a particularly wide distribution or/and a bimodal or multimodal distribution, the smaller particles here can at least partly close gaps and the wedges between the larger particles and, where appropriate, form particularly dense particle layers. For this, for example, two or three different dispersions which are compatible with one another can be mixed with one another. Preferably also, the aqueous particle-containing composition has a pH in the range of from 2 to 13, in particular in the range of from 3.5 to 12 or from 5 to 11, very particularly preferably in the range of from 7 to 10 or from 8 to 9.

Particles which can be used, or also used in addition to other types of particles, in the aqueous composition or/and in the particle layer formed therefrom are, preferably, oxides, hydroxides, carbonates, phosphates, phosphosilicates, silicates, sulfates, organic polymers, waxes or/and compounded particles, in particular those based on corrosion protection pigments, organic polymers, waxes or/and compounded particles. Compounded particles contain a mixture of at least two different substances in one particle. Compounded particles can often contain other substances with very different properties. For example, they can contain part of or the entire composition for a lacquer, optionally even with a content of substances of non-particulate structure, such as e.g. surfactant, defoamer, dispersing agent, lacquer auxiliary substance, further types of additives, dyestuff, corrosion inhibitor, sparingly water-soluble corrosion protection pigment or/and other substances which are conventional or/and known for corresponding mixtures. Such lacquer constituents can be suitable or/and frequently used for example for organic coatings for reshaping, for corrosion protection primers and other primers, for coloured lacquers, fillers or/and clear lacquers. A corrosion protection primer conventionally contains electrically conductive particles and is electrically weldable. Generally, it is often preferable here for a) a mixture of chemically or/and physically different particles, b) particles, aggregates or/and agglomerates of chemically or/and physically different particles or/and c) compounded particles to be used in the composition or/and in the particle layer formed therefrom.

It is frequently preferable for the particle-containing composition or/and the particle layer formed therefrom also to contain, in addition to at least one type of particles, at least one non-particulate substance, in particular additives, dyestuffs, corrosion inhibitors or/and sparingly water-soluble corrosion protection pigments. On the other hand, in some embodiments it is preferable for the composition or/and the coating formed therefrom also to contain, in addition to at least one type of organic particles, at least one non-particulate silicon-containing substance, in particular in each case at least one silane/silanol/siloxane/polysiloxane/silazane/polysilazane.

In particular, coloured or/and optionally also a limited content of electrically conductive particles, in particular based on fullerenes and other carbon compounds with graphite-like structures or/and carbon black, optionally also nanocontainers or/and nanotubes, can be contained as particles in the composition or/and in the particle layer formed therefrom. On the other hand, coated particles, chemically or/and physically modified articles, core-shall particles, compounded particles of various substances, encapsulated particles or/and nanocontainers can be used here in particular as particles in the composition or/and in the coating formed therefrom.

In the process according to the invention, organic polymers, in particular based on aminoplast, epoxide, ethylene acrylate, alkyl (meth)acrylate, polyethylene, polyisobutylene, polyacrylonitrile, polyvinyl chloride, poly(meth)acrylate, polyalkyl (meth)acrylate, such as e.g. polymethyl methacrylate, polyvinyl acetate, polyvinyl alcohol, polyvinylidene chloride, polytetrafluoroethylene, polyisoprene, polypropylene, poly(meth)acrylate, polyester, polyether, polyurethane, phenolic resin, alkyd resin, polycarbonate, polyamide, polystyrene, polysulfide, polysiloxane, polyvinyl acetate, polyacetal, styrene acrylate, derivatives thereof, compoundings thereof or/and mixtures thereof, can be used as particles in the particle-containing composition, in the particle layer or/and in the coating formed therefrom.

In many embodiments, pigments or/and additives such as are often used in lacquers and primers are advisable as additives to the organic polymers of the particles.

In the process according to the invention, it is preferable for the particle-containing composition, the particle layer formed therefrom or/and the coating formed therefrom, e.g. by film formation or/and crosslinking, also to contain, in addition to at least one type of particles, in each case at least a dyestuff, a coloured pigment, a corrosion protection pigment, a corrosion inhibitor, a conductivity pigment, a further type of particles, a silane/silanol/siloxane/polysiloxane/silazane/polysilazane, a lacquer additive or/and an additive, such as e.g. in each case at least a surfactant, a defoamer or/and a dispersing agent.

In the process according to the invention, it is preferable for the composition or/and the coating formed therefrom to contain, in addition to at least one type of particles and optionally in addition to at least one non-particulate substance, part of or a complete chemical composition for a primer, a lacquer, such as, for example, for a filler, top lacquer or/and clear lacquer.

Preferably, the particle-containing composition has a viscosity in the range of from 1 to 10,000 mPa·s, measured with a Modular Compact Rheometer Physica MCR 300 rotary viscometer from Paar Physica in accordance with DIN EN ISO 3219. Particularly preferably, it has a viscosity in the range of from 4 to 5,000 or from 8 to 1,200 mPa·s, very particularly preferably in the range of from 15 to 800, from 20 to 450, from 40 to 350 or from 60 to 250 mPa·s.

In the process according to the invention, the particle-containing composition can preferably have a zeta potential in the range of from −200 to +200 mV, measured at the pH values of a stable dispersion. Particularly preferably, it has a zeta potential in the range of from −150 to +150 or from −100 to +100 mV, very particularly preferably in the range of from −80 to +40 mV. The zeta potential characterizes the surface charge of the particles. This property was measured with a Zetasizer Nano ZS from Malvern Instruments Ltd. The pH values and conditions under which the dispersion (=suspension or/and emulsion) is stable, that is to say does not flocculate out or/and does not coagulate more severely over a relatively long period of time in an aqueous liquid were chosen here. If the zeta potential is too high, it may happen that particles are kept at a distance in the particle layer because of the forces of repulsion and cannot form a dense particle packing. If the zeta potential is too low, it may happen that particles are not attracted sufficiently by the activated surface and that no adequate covering is achieved.

The pH of this composition can be varied within wide limits and adapted to the suitable pH values. The coating can be carried out at temperatures in particular of between 5 and 95° C., preferably at room temperature or at temperatures of between 15 and 50° C.

The coating with the particle-containing composition can be carried out by any type of application, in particular, for example, by spraying, dipping, rolling on etc. The coating can be carried out in particular with a dispersion which contains particles charged oppositely to the activation layer.

In the process according to the invention, in some embodiments it is preferable if during in each case one coating step with the particle-containing composition, regardless of the subsequent continuation of the coating, in each case a coating with an average thickness of from one to ten or from one to five particle layers or of from one to ten or from one to five average particle sizes is formed on the surfaces to be coated. This coating process is often a self-regulating process, so that a coating is formed only for a certain time and e.g. according to the electrostatic forces—regardless of how long the contact with the particle-containing composition lasts.

Preferably, in the process according to the invention in some embodiments substantially only about a monolayer of the particles is formed on the, in particular, metallic surface or on the optionally precoated, in particular metallic surface. In other embodiments, a particle layer which is not completely closed but is sufficient still to produce a substantially closed or closed coating from the particle layer is formed. In other embodiments in turn, a layer of particles which in particular has an average thickness of from one to, for example, ten average particle sizes is deposited.

In many embodiments, the particle density on the coated surfaces is

of the order of about 2×10¹⁰ particles per mm² (in particular at particle diameters of the order of approximately 10 nm—in 1 layer), of about 2×10¹¹ particles per mm² (in particular at particle diameters of the order of approximately 10 nm—in approximately 5 layers),

of the order of about 2×10⁸ particles per mm² (in particular at particle diameters of the order of approximately 100 nm—in 1 layer), of about 2×10⁹ particles per mm² (in particular at particle diameters of the order of approximately 100 nm—in approximately 5 layers),

of the order of about 2×10⁶ particles per mm² (in particular at particle diameters of the order of approximately 1 μm—in 1 layer), of about 2×10⁷ particles per mm² (in particular at particle diameters of the order of approximately 1 μm—in approximately 5 layers),

of the order of about 2×10⁴ particles per mm² (in particular at particle diameters of the order of approximately 10 μ—in 1 layer), of about 2×10⁵ particles per mm² (in particular at particle diameters of the order of approximately 10 μm—in approximately 5 layers),

of the order of about 750 particles per mm² (in particular at particle diameters of the order of approximately 40 μm—in 1 layer), or of about 7,500 particles per mm² (in particular at particle diameters of the order of approximately 40 mm—in approximately 5 layers).

The particle density on the coated surfaces is often so high that a substantially closed or a closed coating is formed from the particles. A substantially closed or even a closed coating is often also formed here over the peaks and valleys of the rough, in particular metallic surface. The degree of covering of the, in particular, metallic surface here, which can be determined on AFM photographs of scanning force microscopy or on SEM photographs, is preferably at least 95%, at least 98% or at least 99%.

In the process according to the invention, it is preferable for a layer of high particle density to be formed with the particle-containing composition. Particularly preferably, in this context a substantially wash-resistant layer of high particle density is formed with the particle-containing composition.

In preliminary experiments it had proved advantageous if the freshly applied and not yet more intensely dried activation layer was washed at least once, in particular with deionized water, or/and was coated directly with particles, in particular with organic or substantially organic particles, without more intensive drying. This resulted in layers which were closed significantly better and significantly higher particle densities. The washing can be carried out in particular as dip washing, in particular in an agitated bath, or as spray washing, e.g. by spraying.

The washing after the particle coating serves to remove particles which are not electrostatically bonded and accumulations, such as e.g. runs, and to make the process operation as realistically close as possible to that which is often conventional in the automobile industry, since washing with water is often carried out in the automobile industry, either by a dip washing or by a spray washing.

If the particle layer is washed after its application, it is preferable for the particles in the particle layer to be kept so wash-resistant that after washing with at least one wash liquid, such as e.g. water or/and an aqueous rinsing liquid, substantially at least one monolayer of particles is retained. In the process according to the invention, it is preferable for the particles to adhere to the, in particular, metallic surface in such a wash-resistant manner that in spite of washing with at least one wash liquid, such as e.g. water or/and an aqueous rinsing liquid with at least one further, in particular dissolved substance, substantially at least one monolayer of particles is retained.

The washing can be carried out in principle in any desired manner and sequence. During each washing, if required washing can be carried out several times, e.g. at least once with deionized water. If required, thereafter washing can be carried out at least once with a less highly purified water quality or/and with a rinsing liquid. Washing is optionally carried out first with municipal water and thereafter with deionized water.

The rinsing liquid can be, for example, one based on an aqueous solution or dispersion with in each case at least one phosphate, one phosphonate, one silane/silanol/siloxane/polysiloxane, one organic polymer, one isocyanate, one isocyanurate, one melamine, with at least one titanium compound, with at least one zirconium compound, with at least one type of particles, with at least one lacquer additive or/and with at least on other additive. A rinsing solution can contribute towards subsequent application of a crosslinking agent, a corrosion protection additive, an adhesion promoter, a sealing layer, a protective layer which closes gaps and wedges or/and a coating for a gradient coating.

In the process according to the invention, it is preferable for the particle layer formed to be washed with at least one wash liquid, such as e.g. water or/and an aqueous rinsing liquid, and thereafter preferably to be coated in the dried or not more intensely dried state with at least one organic composition, e.g. a primer or/and lacquer.

Preferably, the at least one particle layer forms a film or/and crosslinks in order to form a coating which is as far as possible closed and, in the case of a metallic substrate, also corrosion-resistant. The film formation or/and crosslinking can be effected in particular during drying or/and heating. The crosslinking can also be partly or completely effected by free radical polymerization or/and additionally by an e.g. thermal post-crosslinking. The crosslinking processes are known in principle.

A film formation can be improved by the use of thermoplastic polymers or/and by addition of substances which serve as temporary plasticizers. Film formation auxiliary substances act as specific solvents which soften the surface of the polymer particles and in this way make their fusion possible. It is advantageous here if these plasticizers on the one hand remain in the aqueous composition for a sufficient length of time in order to be able to act on the polymer particles for a long time, and thereafter evaporate and therefore escape from the film.

So-called long-chain alcohols, in particular those having 4 to 20 C atoms, such as a butanediol, a butyl glycol, a butyl diglycol, an ethylene glycol ether, such as ethylene glycol monobutyl ether, ethylene glycol monoethyl ether, ethylene glycol monomethyl ether, ethyl glycol propyl ether, ethylene glycol hexyl ether, diethylene glycol methyl ether, diethylene glycol ethyl ether, diethylene glycol butyl ether, diethylene glycol hexyl ether, or a polypropylene glycol ether, such as propylene glycol monomethyl ether, dipropylene glycol monomethyl ether, tripropylene glycol monomethyl ether, propylene glycol monobutyl ether, dipropylene glycol monobutyl ether, tripropylene glycol monobutyl ether, propylene glycol monopropyl ether, dipropylene glycol monopropyl ether, tripropylene glycol monopropyl ether, propylene glycol phenyl ether, trimethylpentanediol diisobutyrate, a polytetrahydrofuran, a polyether polyol or/and a polyester polyol, are particularly advantageous as film formation auxiliary substances.

A crosslinking can be effected, for example, with certain reactive groups, such as e.g. isocyanate, isocyanurate or/and melamine groups.

Preferably, the particle layer is dried in a manner such that, in particular, a film can be formed from organic polymer particles present, so that a largely or completely homogeneous coating is formed. In some embodiments, the drying temperatures chosen in this context can be so high that the organic polymeric constituents can crosslink.

In the process according to the invention, in several embodiments it is preferable for a particle layer containing substantially organic particles to be formed and, for example, to form a film or/and crosslink during drying. In some embodiments the film formation also takes place without the presence of film formation auxiliary substances. The particles of the coating here, in particular if they are present predominantly or entirely as organic polymers, can be formed into a film preferably to give a substantially closed or to give a closed coating, in particular during drying. It is often preferable here for the drying temperature of a coating which consists predominantly or entirely of organic polymers to be chosen such that a substantially closed or a closed coating is formed. If required, at least one film formation auxiliary substance, in particular based on at least one long-chain alcohol, can be added for the film formation. In embodiments with several particle layers on top of one another, preferably all the particle layers are first applied and thereafter formed to a film or/and crosslinked together.

It is frequently preferable here for the drying, film formation or/and crosslinking to take place in the temperature range of from 5 to 350° C., from 8 to 200° C., from 10 to 150° C., from 12 to 120° C. or from 14 to 95° C., particularly preferably in the temperature range of from 16 to 40° C., based on the oven temperature and/or based on the peak metal temperature (PMT). The temperature range chosen largely depends on the nature and amount of the organic and optionally also the inorganic constituents and where appropriate also on their film formation temperatures or/and crosslinking temperatures.

In the process according to the invention, it is particularly preferable for the particle layer formed to be washed with a wash liquid, such as e.g. water or/and at least one aqueous rinsing liquid and thereafter, in the wet, damp or superficially dried state, to be coated with at least one organic composition of a primer or/and lacquer or/and to be coated with further particles of opposite charge to the particles of the previously applied particle layer.

In the process according to the invention, in particular embodiments it is preferable for at least two layers of particles to be formed on top of one another, in particular in each case with layers of alternately positively and negatively charged particles. In the process according to the invention, in particular embodiments it is preferable for at least two layers and from these at least two coatings to be formed on top of one another from at least two particle layers or for these layers to be converted partly or completely into a single coating which optionally has chemical or/and physical gradients, in particular in each case from layers of alternately positively and negatively charged particles. In such alternate Iayerings, the subsequent particle layer can be deposited either on the particle layer or on the coating formed from the particles. If the particular coating produced from the particles has a sufficient number of charges or/and if it is additionally even more strongly negatively or positively charged, e.g. with an alkaline or acid treatment, such as in the intensification of the activation, a next layer of particles can be deposited electrostatically thereon.

Before the application of particles, it is advantageous to add to the particle-containing composition at least one substance with anionic or at least one substance with cationic groups in order to charge the particles of the composition with charges. The substances which are preferred for this have already been mentioned in the case of the activating agents and in the case of the intensifying agents.

It is conventionally advantageous if the particles deposited here in various layers on top of one another are alternately anionically and cationically charged, in order to make electrostatic attraction between the various layers possible and to produce as far a possible no defects and no separating layers, such as e.g. detachments of layers, chippings, lumping, phase separations, cracks and delaminations in and between the coatings, and optionally also in order to be chemically compatible and/or compatible with one another in the film formation process. It may be advantageous in this context if the various types of particles in layers on top of one another bond to one another by a suitable chemical reaction by generation of covalent bonds, such as addition, condensation or/and substitution reactions, such as e.g. in reactions between an amine group with an epoxy group or between an alcoholic group with a carboxyl group by esterification or between an alcoholic group or/and an amine group with an isocyanate group or/and blocked isocyanate group.

Surfaces which can be employed are in principle surfaces of all types of materials—optionally also of several different materials adjacent to one another or/and successively in the process—in particular all types of metallic materials. Among the metallic materials in principle all types of metallic materials are possible, in particular those of aluminium, iron, copper, titanium, zinc, tin or/and alloys with a content of aluminium, iron, steel, copper, magnesium, nickel, titanium, zinc and/or tin, it also being possible for them to be employed adjacent to one another or/and successively. The material surfaces can optionally also be precoated, for example with zinc or an alloy containing aluminium or/and zinc. For example, objects of plastic can already be provided with a metallic coating.

In principle all types of objects can be employed as objects to be coated, in particular those of at least one metallic material or/and with at least one metallic coating. Particularly preferred objects are, in particular, belts (coils), metal sheets, parts, such as e.g. small parts, joined components, components of complicated shape, profiles, rods or/and wires.

In the case of a prior pretreatment before an activation of a surface with an activating agent which is intended to help to charge the surface electrostatically, if required the surfaces to be treated can first be subjected to alkaline cleaning and optionally be contacted with a composition for pretreatment, the latter forming, in particular, a conversion layer. The surfaces treated or/and coated in this way can then optionally be coated with a primer or/and with an optionally reshapable protective layer, in particular with a corrosion protection layer, or/and optionally oiled. The oiling serves in particular for temporary protection of the treated or/and coated, in particular metallic surfaces.

In principle any type of pretreatment is possible as the pretreatment: For example, aqueous pretreatment compositions based on phosphate, phosphonate, silane/silanol/siloxane/polysiloxane, lanthanide compound, titanium compound, hafnium compound, zirconium compound, acid, metal salt or/and organic polymer can be employed.

In the further treatment of these coated substrates, an, in particular, alkaline cleaning can be carried out if required, regardless of whether or not oil has been applied beforehand.

A coating with a corrosion protection primer, such as e.g. a welding primer, can render possible additional corrosion protection, in particular in cavities and poorly accessible areas of a substrate, reshapability or/and joinability, e.g. with folding, gluing or/and welding. In industrial practice, a corrosion protection primer could be employed, in particular, if the substrate coated with it, such as e.g. a metal sheet, is shaped or/and joined with a further component after the coating with the corrosion protection primer and if further coatings are applied only thereafter. If in this process operation a corrosion protection primer is additionally applied under the activation layer and under the particle coating, a significantly improved corrosion protection is usually generated.

After application of the activation layer and the particle layer and optionally after production of a substantially closed or a closed coating from the particle layer, at least one substantially organic, organic or substantially inorganic layer, such as e.g. the layer of a binder, adhesive, adhesion promoter, primer or/and lacquer, can be applied to this layer or coating. It is particularly preferable for at least one layer of a lacquer or even a lacquer build-up, e.g. of base lacquer and clear lacquer, or of any desired lacquer system, to be applied to the substantially closed or closed coating. If a further organic coating is applied thereafter, a colouring or/and a matting or a possibility of joining can be achieved with it. In other embodiments it may be preferable for the surfaces coated in this manner to be shaped or/and to be joined with at least one other component or/and for an adhesive layer or/and at least one tacky moulding to be applied before a gluing operation.

In the process according to the invention, the particles are preferably held in the particle layer in such a wash-resistant manner that after at least one washing with a wash liquid, such as e.g. water or/and at least one aqueous rinsing liquid, substantially at least a monolayer of particles is retained.

In the process according to the invention, the particles are preferably held on the, in particular, metallic layer in a wash-resistant manner in such a way that in spite of at least one washing with a wash liquid, such as e.g. water or/and at least one aqueous rinsing liquid, substantially at least a monolayer of particles is retained.

The treatment steps and the possible compositions before the activation step and after the formation of a coating from the particle layer are known in principle to the person skilled in the art and can be varied in diverse ways.

The invention is also achieved with a coating which has been produced by the process according to the invention.

The coating according to the invention can preferably be employed for coated substrates as a wire, braided wire, belt, metal sheet, profile, lining, part of a vehicle or aircraft, element for a domestic appliance, element in building construction, stand, element of a crash barrier, radiator or fence, moulding of complicated geometry or small part, such as e.g. screw, nut, flange or spring. It is particularly preferably employed in automobile construction, in building construction, for apparatus construction, for domestic appliances or in heating installation.

It has been found that from the surfaces coated according to the invention with particles, substantially closed or closed coatings can subsequently be produced with a layer thickness in the range of from 5 nm to 50 μm, in particular in the range of from 15 nm to 40 μm, from 25 nm to 30 μm, from 45 nm to 20 μm, from 60 nm to 15 μm, from 80 nm to 10 μm, from 100 nm to 8 μm, from 130 nm to 6 μm, from 160 nm to 4 μm, from 200 nm to 2 μm or from 400 nm to 1 μm. The individual particle layers can have corresponding layer thicknesses before their film formation or/and before their crosslinking.

It has been found that it was possible for the surfaces coated according to the invention with particles, from which substantially closed or closed coatings were subsequently produced, to be produced in a significantly simpler and significantly less expensive manner than, for example, electro-dip lacquer or powder lacquer coatings.

It has furthermore been found that such coatings produced according to the invention can be equivalent in their properties to electro-dip lacquer or powder lacquer coatings of current industrial practice when particles of corresponding chemical composition, in particular larger particles, are employed.

It has been found, surprisingly, that the process according to the invention, which is not or substantially not an electrolytic process, even in the case where it is assisted slightly with an electrical voltage, and therefore conventionally requires no application of an external electrical voltage, can be operated in a simple manner and without expensive control. This process can be employed in a wide temperature range and also at room temperature, apart from the subsequent drying.

An advantage of the process according to the invention moreover lies in the fact that the coating is also applied around corners, edges and peaks, in particular because of its electrostatic design. This lies in the nature of the coating process, which requires no electrical voltage and therefore functions independently of electric field lines.

It has been found, surprisingly, that in the process according to the invention, no expensive control measures are necessary with respect to the application of the activating agent, and high-quality protective coatings are formed with a low consumption of chemicals.

It has been found, surprisingly, that in the process according to the invention, a self-regulating process often takes place with respect to the electrostatic deposition of the, in particular, organic particles, in which no expensive control measures are necessary and high-quality protective coatings are formed with a low consumption of chemicals.

It has been found, surprisingly, that the dispersions of organic polymer particles employed allowed particle layers to be formed on the electrostatically charged surface which not only was it possible to convert into largely closed or closed, largely homogeneous or homogeneous coatings—in contrast to the same dispersions which were applied without corresponding activation of the surface, but that it was also possible for the particle layers to be anchored on the surface in a substantially wash-resistant manner.

It has furthermore been found, surprisingly, that the coatings produced according to the invention can have a significantly improved corrosion protection for their layer thickness.

It has furthermore been found, surprisingly, that depending on the choice of the substrate, of the various activating agents and of the various particle dispersions, coatings according to the invention can be produced which can be adapted in their lacquer adhesion and their corrosion protection individually to the particular requirements.

### FIGURES

FIG. 1A: Outline of the principles of formation of a thin dry film according to the prior art, e.g. in coil coating.

FIG. 1B: Outline of the principles of deposition of a thick CDC layer in a layer thickness L of approx. 25 μm according to the prior art.

FIG. 1C: Outline of the principles of formation of a thin dry film by a process according to the invention.

FIG. 2A: SEM photograph of a metal sheet which has been cleaned and not further treated (CE1).

FIG. 2B: SEM photograph of a metal sheet activated by silane treatment without subsequent acid treatment, but after treatment with a polymer particle dispersion, still without film formation (E12).

FIG. 2C: SEM photograph of a metal sheet activated by silane treatment with subsequent acid treatment and after treatment with a polymer particle dispersion, film already formed (E7). The photograph indicates that due to a dense particle coating which also wraps around edges and peaks, after film formation a uniform, largely homogeneous or homogeneous coating which also covers the edges and peaks results, which due to this high-quality covering and homogeneity can lead to an increased corrosion protection. The cracks detectable on the photograph can be at least partly avoided in the process according to the invention. They are partly the consequence of irradiation with an electron beam under the scanning electron microscope and can be healed up or/and filled out during subsequent treatment.

FIG. 2D: SEM photograph of a cleaned metal sheet which has been treated not with an activating agent but only with a polymer particle dispersion, still without film formation (CE12). Compared with FIGS. 2B and 2C, only very few particles have been deposited.

FIG. 3: SEM photograph of a metal sheet activated by silane treatment without subsequent acid treatment, but after treatment with a polymer particle dispersion (still without film formation). This figure shows the same specimen as FIG. 2B, but in a higher magnification. It is intended to illustrate the contrast to the still more homogeneous and still denser covering of FIG. 4. (E12).

FIG. 4: Metal sheet activated by silane treatment with subsequent acid treatment and after treatment with a polymer particle dispersion. This AFM photograph by an atomic force microscope of the type QS 01830 from Currents shows a surface of the particle layer without film formation compared with FIG. 3, the acid treatment having led to a still denser layer containing fewer and smaller gaps (E28). The photograph indicates that with the dense particle coating which also wraps around edges and peaks, after film formation a uniform, largely homogeneous or homogeneous coating which also covers the edges and peaks results, which due to this high-quality covering and homogeneity can lead to an increased corrosion protection.

### EXAMPLES AND COMPARISON EXAMPLES

The examples (E) described in the following and the comparison examples (CE) are intended to illustrate the subject matter of the invention in more detail.

Explanation of the process steps and compositions:

CPP=corrosion protection primer, PT=pretreatment

Substrate type (metal sheets):

1: Electrolytically galvanized steel sheet with a zinc layer deposit of 5 μm, sheet thickness 0.81 mm.

2: Hot-dip galvanized steel sheet, sheet thickness approx. 0.8 mm.

3: Cold-rolled steel, sheet thickness approx. 0.8 mm.

4: Aluminium alloy of grade AC 170, sheet thickness approx. 1.0 mm.

Various aqueous solutions or dispersions were prepared for contacting or/and coating these metal sheets.

### I. Prior Pretreatment

In the prior pretreatment before the activation of the surface with an activating agent which is intended to help to charge the surface electrostatically, if required the metallic surfaces to be treated were first subjected to alkaline cleaning and where appropriate contacted with a composition for pretreatment, in order to form a conversion layer, and were then, where appropriate, coated with a corrosion protection primer and, where appropriate, oiled. The oiling served in particular for temporary protection of the cleaned or/and coated metallic surfaces. During the further treatment of these coated substrates, an alkaline cleaning was carried out, regardless of whether or not oil had been applied beforehand.

### Alkaline Cleaning During the Pretreatment:

1: Gardoclean® S 5160 from Chemetall GmbH. Preparation and process conditions: Prepare 20 g/l with municipal water, spray at 60° C. for 20 s, subsequently wash with municipal water for 20 s, thereafter wash with completely demineralized water and dry.

### Chromium-Free Pretreatment:

1: Based on TiF₆, ZrF₆, PO₄, silane and polymer, layer deposit 4-6 mg/m² of Ti.

2: Based on TiF₆, PO₄, silane and organic substances, layer deposit 6-9 mg/m² of Ti.

### Corrosion Protection Primer, Applied by Means of Roll Coating:

1: Gardoprotect® 9493 from Chemetall GmbH, layer thickness approx. 3.8 μm.

2: CPP based on zinc, polyepoxide and isocyanate, layer thickness approx. 3.0 μm

In the present experiments, on application of a corrosion protection primer the specimens were subsequently neither shaped nor joined. When in this process operation a corrosion protection primer was additionally applied under the activation layer and under the particle coating, a significantly improved corrosion protection was determined.

### Oiling:

1: By means of dipping in a petroleum gasoline solution with 5 vol. % of a corrosion protection oil.

### Alkaline Cleaning Where Appropriate After an Oiling:

1: For removal of the oil or/and only for cleaning: Gardoclean® S5176 and Gardobond® Additiv H7406 from Chemetall GmbH prepared in municipal water. Metal sheets treated at 60° C. for 3 min by spraying and 2 min by dipping and then sprayed off with municipal water for 30 s and with deionized water for 30 s.

### II. Activation

The activation serves to charge the surfaces with many charges. If cationically charged activating agents are applied to the surfaces, the particles to be applied must be anionically charged in order to be correspondingly attracted and anchored. If anionically charged activating agents are applied to the surfaces, the particles to be applied must be cationically charged in order to be correspondingly attracted and anchored.

### Electrostatic Charging of the Surfaces:

### A) With Cationically Charged Activating Agents:

1: Ethoxysilane with amine functionalities, ZrF₆, cations,

2: Modified ethoxysilane with amine functionality, ZrF₆, cations.

3: More highly modified ethoxysilane A with amine functionality, ZrF₆, cations; pH 3.8-4.2.

4: More highly modified ethoxysilane B with amine functionality, ZrF₆, cations; pH 4.0-4.5.

5: SIVO® 110 from Evonik Industries AG (solution with condensed silane with amine functionality), ZrF₆, cations; pH 4-9.

### B) With Anionically Charged Activating Agents:

6: Aqueous solution based on sodium polyacrylate; pH 9.

### III: Washing of the Activation Layer

Since some of the fresh coating is washed off during the washing operation, the remaining contents of the activation layer are determined together with element contents of the residues of cleaning agents, the pretreatment layer, the corrosion protection primer layer etc. It proved to be advantageous if the highest possible content of the activation layer is retained during washing.

The element contents of the activation layer were determined by means of x-ray fluorescence analysis (XRFA) for the activation layer, including the contents from prior treatments—if present. The data relate to the element contents after washing. The remaining layer thicknesses can be estimated and compared from sample to sample by this means, it being illustrated that in spite of intensive washing, comparatively high contents of the activation layer are retained. These contents are sufficient to actively prepare the activated surface for the subsequent treatment steps IV and V.

Parallel investigations with atomic force microscopy (AFM, scanning force microscopy) and with scanning electron microscopy (SEM) illustrate that closed coatings are formed from the combination of the contacting with activating agent based on silane, optionally by the subsequent positive charging by acid treatment, by coating with organic particles and by film formation or/and crosslinking of the particle layer.

### IV: Positive Charging by Acid Treatment or Negative Charging by Base Treatment

If an activating agent has functionalities, the functionalities can be positively charged, for example, by an acid treatment in order to make possible an even higher and as far as possible complete charging with protons and/or cations. The nitrogen-containing groups, in particular the amine functionalities, above all of silanes, can be more strongly positively charged by the acid treatment in this way. This acid treatment furthermore makes possible the use of silanes in a pH range suitable for these silanes. Scanning electron microscopy photographs showed a significantly denser and more uniform deposition of particles due to this treatment.

Acid Treatment at Room Temperature For as Far as Possible Complete Charging With Protons or/and Cations:

1: Dipping in acetic acid 0.26 mol/l in deionized water.

2: Dipping in phosphoric acid 0.087 mol/l in deionized water.

3: Dipping in nitric acid 0.26 mol/l in deionized water.

4: Dipping in sulfuric acid 0.13 mol/l in deionized water.

Thereafter, the correspondingly positively charged coated metal sheets were washed with deionized water by dipping in order to remove excess acid, and to configure the process operation as realistically close as possible to that which is conventional in the automobile industry.

### V. Coating of the Electrostatically Charged Surfaces With Oppositely Charged Particles

C) Anionically stabilized aqueous polymer particle dispersions (PU=polyurethane). All the solids contents were adjusted to 30 wt. %.

1: Polyurethane dispersion A from Alberdingk-Boley. Average particle size d₅₀ 150 nm. Viscosity 20-400 mPa·s. Zeta potential −50 mV. Minimum film formation temperature 25° C. pH 7-8.

2: Oxidatively drying polyester-polyurethane dispersion B from Bayer MaterialScience AG. Average particle size d₅₀ 125 nm. Viscosity 200-350 mPa·s. Zeta potential −60 mV. Minimum film formation temperature 10-15° C. pH 7.2.

3: Dispersion C based on polyacrylate. Average particle size d₅₀ 125 nm. Viscosity 400 mPa·s. Zeta potential −65 mV. Minimum film formation temperature 19° C. pH 8.

4: Dispersion D based on polyacrylate. Average particle size d₅₀ 150 nm. Viscosity 20 mPa·s. Zeta potential −51 mV. Minimum film formation temperature 40° C. pH 8.

5: Polyether-polyurethane dispersion E from Bayer MaterialScience AG. Average particle size d₅₀ 250-500 nm. Viscosity 100 mPa·s. Zeta potential −57 mV. Minimum film formation temperature 20° C. pH 7-8.5.

6: Polyester-polyurethane dispersion F from Bayer MaterialScience AG, Average particle size d₅₀ 200-400 nm. Viscosity 200 mPa·s. Zeta potential −50 mV. Minimum film formation temperature 25° C. pH 7-8.

7: Anionic and nonionic polyester-polyurethane dispersion G from Bayer MaterialScience AG. Average particle size d₅₀ 140 nm. Viscosity 80 mPa·s. Zeta potential −83 mV. Minimum film formation temperature 30° C. pH 6-8.

8: Anionic and nonionic dispersion H from Bayer MaterialScience AG. Average particle size d₅₀ 120 nm, Viscosity 110 mPa·s. Zeta potential −80 mV. Minimum film formation temperature 15° C. pH 7.

9: Anionic and nonionic dispersion I from Bayer MaterialScience AG. Average particle size d₅₀ 170 nm. Viscosity 90 mPa·s. Zeta potential −84 mV. Minimum film formation temperature 30° C. pH 7.

10: Anionic and nonionic dispersion J from Bayer MaterialScience AG. Average particle size d₅₀ 110 nm. Viscosity 40 mPa·s. Zeta potential −82 mV. Minimum film formation temperature 25° C. pH 7.

### Anionically or Cationically Stabilizing Groups for the Anionic Polymer Particle Dispersions:

1: Anionic groups A in water.

2: Anionic carboxylate groups in water.

3: Cationic groups B in water.

### D) Cationically Stabilized Aqueous Polymer Particle Dispersions:

11: Cationically stabilized aliphatic polyester-urethane dispersion J from Picassian Polymers. Average particle size d₅₀ 100 nm. Viscosity 550 mPa·s. Zeta potential +50 mV. Minimum film formation temperature 20° C. pH 5.

12: Cationically stabilized polyurethane dispersion K from Picassian Polymers. Average particle size d₅₀ 120 nm. Viscosity 300 mPa·s. Zeta potential +60 mV. Minimum film formation temperature 15° C. pH 5.

Coating was carried out by dipping the activated and washed and, where appropriate, acid-treated metal sheets in a dispersion of oppositely charged particles at room temperature. Thereafter, these particle-charged surfaces were washed with deionized water by dipping at room temperature and dried in a manner such that the polymer particles were able to form a film, so that a largely or completely homogeneous coating was formed. The drying temperatures chosen were so high that the organic polymeric constituents were able to crosslink.

The washing after the particle coating serves to remove particles that are not electrostatically bonded and accumulations, such as e.g. runs, and to configure the process operation to be as realistically close as possible to that which is conventional in the automobile industry, since washing with water is conventionally carried out in the automobile industry either by a dip washing or by a spray washing.

Drying or Drying with Film Formation in Particular of the Organic Polymeric Constituents:

1: 120° C. for 5 min.

2: 160° C. for 1 min.

Parallel investigations with atomic force microscopy (AFM) and with scanning electron microscopy (SEM) illustrated that according to the invention particle layers with a sufficiently high particle density were formed, from which it was possible to form largely closed or closed coatings from the combination of contacting with activating agent based on silane, optionally by additional positive charging by acid treatment, and by coating with organic particles. The microscope photographs show a homogeneous distribution of the organic particles, while in some specimens without the positive charge somewhat less closed coatings occurred by acid treatment, which indicates a somewhat less strong charging.

### VI. Further Tests

A further lacquering was applied only in order to be able to determine the lacquer adhesion.

Lacquering with Lacquer Build-Up No.:

1: Three-layered lacquer build-up according to the standard lacquer build-up of Daimler AG with a function layer in silver grey, with a water-based lacquer in iridium silver and with clear lacquer.

The lacquer adhesion was determined in many examples by the cross-hatch and the stone-chip test. The cross-hatch was determined in accordance with EN ISO 2409. The cross-cut was 2 mm. In the tables, the adhesion of the lacquer build-up was rated from 0 to 5 by the method described in the standard (rating 0=best rating). The stone-chip was determined in accordance with DIN EN ISO 20567-1 and rated from 0 to 5 by the test model described in the standard (rating 0=best rating).

All the determinations of the corrosion resistance were undertaken without additionally applied lacquer layer(s). The VDA alternating test was carried out in accordance with VDA test sheet 621-415 with an alternating test in a chamber according to a particular cycle over as many cycles as possible of in each case 7 days until the first appearance of white or/and red rust, testing being performed weekly. The salt spray mist testing was carried out in accordance with DIN EN ISO 9227 NSS and the condensation water alternating climate test was carried out in accordance with DIN EN ISO 6270-2. The CASS test for aluminium and aluminium alloys was carried out in a salt spray chamber compatible with DIN EN ISO 9227 CASS. Testing was carried out in this way for the number of days before white rust occurred. The number of days in hours until the first occurrence of white rust is stated, testing being performed daily.

The filiform test for aluminium and aluminium alloys was carried out in a test chamber which can be closed air-tight in accordance with DIN EN 3665. The number of days in hours until the first occurrence of white rust is stated, testing being performed daily.

The following tables reproduce an extract by way of example of the experiments carried out and the results thereby obtained.

### TABLES

### Overview of the Compositions of the Solutions/Dispersions Employed, the Process Sequences and the Properties of the Coatings Produced Therewith

| | Comparison Ex. | | | | | | | |
|---|---|---|---|---|---|---|---|---|
| Contents in g/l | CE 1 | CE 2 | CE 3 | CE 4 | CE 5 | CE 6 | CE 7 | CE 8 |
| Substrate type no. | 1 | 4 | 1 | 1 | 4 | 1 | 1 | 1 |
| Prior treatment: | | | | | | | | |
| Alkal. cleaning no. before CE | — | — | 1 | 1 | — | — | 1 | 1 |
| Pretreatment (CE) no. | — | — | 1 | 2 | — | — | 1 | 2 |
| Corrosion protection primer no. | — | — | 1 | 2 | — | — | 1 | 2 |
| Oiling | — | — | 1 | 1 | — | — | 1 | 1 |
| Alkaline cleaning no. where | 1 | 2 | 1 | 1 | 1 | 1 | 2 | 1 |
| appropriate after oiling | | | | | | | | |
| Activation: | | | | | | | | |
| Activating agent no. | — | — | — | — | 3 | 3 | 3 | 3 |
| Element contents in this | | | | | | | | |
| process stage (after washing) | | | | | | | | |
| Si mg/m² | <1 | 10 | 106 | 109 | 17 | 19 | 116 | 108 |
| Ti mg/m² | <1 | 6 | 30 | 8 | 6 | <1 | 4 | <1 |
| Zr mg/m² | <1 | <1 | <1 | 2 | 13 | 43 | 10 | 13 |
| Mn mg/m² | 18 | 23 | 30 | 38 | 23 | 18 | 33 | 41 |
| Acid treatment: | | | | | | | | |
| Acid no. | — | — | — | — | — | — | — | — |
| Aqueous polymer dispersion: | | | | | | | | |
| Polymer particles no. | — | — | — | — | — | — | — | — |
| Stabilizing groups no. | — | — | — | — | — | — | — | — |
| Drying no. | 1 | 1 | 1 | 1 | 1 | 1 | 1 | 1 |
| Drying with film formation no. | — | — | — | — | — | — | — | — |
| Lacquer adhesion (lacquered | | | | | | | | |
| with film formation): | | | | | | | | |
| Cross-hatch (before/after | — | — | — | — | 0/0 | 0/0 | 1/1 | 0/0 |
| loading) | | | | | | | | |
| Stone-chip | — | — | — | — | 0.5 | 0.5 | 0.5 | 0.5 |
| Corrosion (non-lacquered with | | | | | | | | |
| film formation): | | | | | | | | |
| VDA - start of white rust, | 1 | — | 3 | 2 | — | 1 | 3 | 2 |
| cycles | | | | | | | | |
| VDA - start of red rust, cycles | 1 | — | 5 | 5 | — | 1 | 6 | 5 |
| CASS test, h | — | 24 | — | — | 24 | — | — | — |
| Filiform test, h | — | 24 | — | — | 24 | — | — | — |

| | Comparison Ex. | | | | | |
|---|---|---|---|---|---|---|
| Contents in g/l | CE 9 | CE 10 | CE 11 | CE 12 | CE 13 | CE 14 |
| Substrate type no. | 1 | 1 | 1 | 1 | 1 | 1 |
| Prior treatment: | | | | | | |
| Alkal. cleaning no. before CE | 1 | 1 | 1 | — | 1 | 1 |
| Pretreatment (CE) no. | 2 | 2 | 2 | — | 2 | 2 |
| Corrosion protection primer no. | 2 | 2 | 2 | — | 2 | 2 |
| Oiling | 1 | 1 | 1 | — | 1 | 1 |
| Alkaline cleaning no. where | 1 | 1 | 1 | 1 | 1 | 1 |
| appropriate after oiling | | | | | | |
| Activation: | | | | | | |
| Activating agent no. | 4 | 5 | — | — | — | 6 |
| Element contents in this | | | | | | |
| process stage (after washing) | | | | | | |
| Si mg/m² | 108 | 105 | 109 | <1 | 108 | 108 |
| Ti mg/m² | 8 | 9 | 8 | <1 | 8 | 7 |
| Zr mg/m² | 14 | 15 | 1 | <1 | 1 | 1 |
| Mn mg/m² | 38 | 44 | 34 | 18 | 35 | 34 |
| Acid treatment: | | | | | | |
| Acid no. | — | — | 1 | — | — | — |
| Aqueous polymer dispersion: | | | | | | |
| Polymer particles no. | — | — | 1 | 3 | 11 | — |
| Stabilizing groups no. | — | — | 1 | 2 | 3 | — |
| Drying no. | 1 | 1 | — | — | — | 1 |
| Drying with film formation no. | — | — | 2 | — | 2 | — |
| Lacquer adhesion (lacquered | | | | | | |
| with film formation): | | | | | | |
| Cross-hatch (before/after | 0/0 | 1/1 | — | — | — | — |
| loading) | | | | | | |
| Stone-chip | 0.5 | 0.5 | — | — | — | — |
| Corrosion (non-lacquered with | | | | | | |
| film formation): | | | | | | |
| VDA - start of white rust, | 2 | 2 | 2 | 1 | 3 | 2 |
| cycles | | | | | | |
| VDA - start of red rust, cycles | 5 | 5 | 5 | 1 | 5 | 5 |
| CASS test, h | — | — | — | — | — | — |
| Filiform test, h | — | — | — | — | — | — |

| | Example | | | | | | | | | |
|---|---|---|---|---|---|---|---|---|---|---|
| Contents in g/l | E 1 | E 2 | E 3 | E 4 | E 5 | E 6 | E 7 | E 8 | E 9 | E 10 |
| Substrate type no. | 1 | 1 | 1 | 1 | 4 | 4 | 1 | 4 | 1 | 1 |
| Prior treatment: | | | | | | | | | | |
| Alkal. cleaning no. before CE | — | — | — | — | — | — | — | — | — | — |
| Pretreatment (CE) no. | — | — | — | — | — | — | — | — | — | — |
| Corrosion protection primer no. | — | — | — | — | — | — | — | — | — | — |
| Oiling | — | — | — | — | — | — | — | — | — | — |
| Alkaline cleaning no. | 1 | 1 | 1 | 1 | 1 | 1 | 1 | 1 | 1 | 1 |
| Activation: | | | | | | | | | | |
| Activating agent no. | 3 | 3 | 4 | 5 | 3 | 5 | 3 | 3 | 3 | 3 |
| Element contents after the | | | | | | | | | | |
| activation and after the washing: | | | | | | | | | | |
| Si mg/m² | 18 | 20 | 7 | 2 | 16 | 12 | 16 | 18 | 19 | 18 |
| Ti mg/m² | <1 | <1 | <1 | <1 | 6 | 6 | <1 | 5 | <1 | <1 |
| Zr mg/m² | 45 | 47 | 36 | 13 | 15 | 6 | 41 | 12 | 45 | 46 |
| Mn mg/m² | 20 | 17 | 3 | 5 | 23 | 23 | 18 | 22 | 21 | 19 |
| Acid treatment: | | | | | | | | | | |
| Acid no. | 1 | 1 | 1 | 1 | 1 | 1 | 1 | 1 | 2 | 3 |
| Aqueous polymer dispersion: | | | | | | | | | | |
| Polymer particles no. | 1 | 2 | 1 | 1 | 1 | 1 | 3 | 3 | 1 | 1 |
| Stabilizing groups no. | 1 | 1 | 1 | 1 | 1 | 1 | 2 | 2 | 1 | 1 |
| Drying no. | — | — | — | — | — | — | — | — | — | — |
| Drying with film formation no. | 2 | 2 | 2 | 2 | 2 | 2 | 2 | 2 | 2 | 2 |
| Lacquer adhesion (lacquered | | | | | | | | | | |
| with film formation): | | | | | | | | | | |
| Cross-hatch (before/after | 1/1 | 0/1.5 | — | — | 0/0 | — | 5/5 | 0/0 | — | — |
| loading) | | | | | | | | | | |
| Stone-chip | 4 | 5 | — | — | 0.5 | — | 3.5 | 0.5 | — | — |
| Corrosion (non-lacquered with | | | | | | | | | | |
| film formation): | | | | | | | | | | |
| VDA - start of white rust, cycles | 2 | 2 | 2 | 2 | — | — | 2 | — | 2 | 2 |
| VDA - start of red rust, cycles | 3 | 3 | 3 | 3 | — | — | 3 | — | 3 | 3 |
| CASS test, h | — | — | — | — | 48 | 48 | — | 48 | — | — |
| Filiform test, h | — | — | — | — | 48 | 48 | — | 48 | — | — |

| | Example | | | | | | | | | |
|---|---|---|---|---|---|---|---|---|---|---|
| Contents in g/l | E 11 | E 12 | E 13 | E 14 | E 15 | E 16 | E 17 | E 18 | E 19 | E 20 |
| Substrate type no. | 1 | 1 | 1 | 1 | 1 | 1 | 1 | 1 | 1 | 1 |
| Prior treatment: | | | | | | | | | | |
| Alkal. cleaning no. before CE | — | — | — | 1 | 1 | 1 | 1 | 1 | 1 | 1 |
| Pretreatment (CE) no. | — | — | — | 1 | 1 | 1 | 1 | 1 | 1 | 1 |
| Corrosion protection primer no. | — | — | — | 1 | 1 | 1 | 1 | 1 | 1 | 1 |
| Oiling | — | — | — | 1 | 1 | 1 | 1 | 1 | 1 | 1 |
| Alkaline cleaning no. after oiling | 1 | 1 | 1 | 1 | 1 | 1 | 1 | 1 | 1 | 1 |
| Activation: | | | | | | | | | | |
| Activating agent no. | 3 | 3 | 3 | 3 | 3 | 3 | 3 | 3 | 3 | 3 |
| Element contents after the activation | | | | | | | | | | |
| and after the washing: | | | | | | | | | | |
| Si mg/m² | 17 | 18 | 19 | 116 | 117 | 117 | 116 | 115 | 116 | 118 |
| Ti mg/m² | <1 | <1 | <1 | 4 | 5 | 5 | 4 | 4 | 3 | 4 |
| Zr mg/m² | 44 | 45 | 46 | 9 | 10 | 10 | 10 | 11 | 10 | 10 |
| Mn mg/m² | 20 | 20 | 21 | 33 | 33 | 34 | 33 | 32 | 33 | 33 |
| Acid treatment: | | | | | | | | | | |
| Acid no. | 4 | — | 1 | 1 | 1 | 1 | 1 | 1 | 1 | 1 |
| Aqueous polymer dispersion: | | | | | | | | | | |
| Polymer particles no. | 1 | 3 | 3 | 1 | 2 | 3 | 4 | 5 | 6 | 7 |
| Stabilizing groups no. | 1 | 2 | 2 | 1 | 1 | 2 | 2 | 1 | 1 | 1 |
| Drying no. | — | — | — | — | — | — | — | — | — | — |
| Drying with film formation no. | 2 | — | — | 2 | 2 | 2 | 2 | 2 | 2 | 2 |
| Lacquer adhesion (lacquered with | | | | | | | | | | |
| film formation): | | | | | | | | | | |
| Cross-hatch (before/after loading) | — | — | — | 1/1 | — | 1/1 | — | — | — | — |
| Stone-chip | — | — | — | 0.5 | — | 0.5 | — | — | — | — |
| Corrosion (non-lacquered with film | | | | | | | | | | |
| formation): | | | | | | | | | | |
| VDA - start of white rust, cycles | 2 | 1 | 2 | 6 | 6 | 6 | 6 | 6 | 5 | 5 |
| VDA - start of red rust, cycles | 3 | 2 | 3 | 13 | 10 | 11 | 10 | 9 | 10 | 10 |
| CASS test, h | — | — | — | — | — | — | — | — | — | — |
| Filiform test, h | — | — | — | — | — | — | — | — | — | — |

Example

| Contents in g/l | E 21 | E 22 | E 23 | E 24 | E 25 | E 26 | E 27 |
|---|---|---|---|---|---|---|---|
| Substrate type no. | 1 | 1 | 1 | 1 | 1 | 1 | 1 |
| Prior treatment | | | | | | | |
| Alkal. cleaning no. before CE | 1 | 1 | 1 | 1 | 1 | 1 | 1 |
| Pretreatment (CE) no. | 1 | 1 | 1 | 2 | 2 | 2 | 2 |
| Corrosion protection primer no. | 1 | 1 | 1 | 2 | 2 | 2 | 2 |
| Oiling | 1 | 1 | 1 | 1 | 1 | 1 | 1 |
| Alkaline cleaning no. | 1 | 1 | 1 | 1 | 1 | 1 | 1 |
| Activation: | | | | | | | |
| Activating agent no. | 3 | 3 | 3 | 3 | 3 | 6 | 6 |
| Element contents after the | | | | | | | |
| activation and after the | | | | | | | |
| washing: | | | | | | | |
| Si mg/m² | 115 | 118 | 116 | 108 | 109 | 107 | 109 |
| Ti mg/m² | 5 | 4 | 4 | 8 | 8 | 9 | 8 |
| Zr mg/m² | 10 | 9 | 10 | 1 | 1 | 1 | 1 |
| Mn mg/m² | 34 | 33 | 33 | 36 | 38 | 38 | 36 |
| Acid treatment: | | | | | | | |
| Acid no. | 1 | 1 | 1 | 1 | 1 | — | — |
| Aqueous polymer dispersion: | | | | | | | |
| Polymer particles no. | 8 | 9 | 10 | 1 | 3 | 11 | 12 |
| Stabilizing groups no. | 1 | 1 | 1 | 1 | 2 | 3 | 3 |
| Drying no. | — | — | — | — | — | — | — |
| Drying with film formation no. | 2 | 2 | 2 | 2 | 2 | 2 | 2 |
| Lacquer adhesion (lacquered | | | | | | | |
| with film formation): | | | | | | | |
| Cross-hatch (before/after | — | — | — | 1/1 | 1/1 | — | — |
| loading) | | | | | | | |
| Stone-chip | — | — | — | 0.5 | 1 | — | — |
| Corrosion (non-lacquered with | | | | | | | |
| film formation): | | | | | | | |
| VDA - start of white rust, cycles | 5 | 5 | 6 | 5 | 4 | 4 | 4 |
| VDA - start of red rust, cycles | 10 | 11 | 10 | 11 | 10 | 7 | 8 |
| CASS test, h | — | — | — | — | — | — | — |
| Filiform test, h | — | — | — | — | — | — | — |

In Comparison Examples CE1 and CE2 bright cleaned metallic surfaces of E-zinc and, respectively, aluminium alloy are present, which were not further treated and not further coated. Their corrosion protection is correspondingly low.

The metal sheets of Comparison Examples CE3 and CE4 were additionally subjected to alkaline cleaning and coated with a pretreatment and with a corrosion protection primer. A significantly increased corrosion resistance results in particular due to the corrosion protection primer.

In Comparison Examples CE5 and CE6 bright cleaned metallic surfaces of E-zinc and, respectively, aluminium alloy are present, which were treated with a silane-containing activating agent, but were not further coated with a particle-containing dispersion. Their corrosion protection is as low as in the case of the metal sheets of Comparison Examples CE1 and CE2, which were only cleaned,

In Comparison Examples CE7 to CE11, in addition to the treatments as in Comparison Examples CE3 and CE4, a treatment with a silane-containing activating agent was also employed, which resulted in a corrosion protection which was as good as or slightly better than in Comparison Examples CE3 and CE4.

In Comparison Example CE12 a polymer particle dispersion was also employed additionally to Comparison Example CE1.

When working with cationic polymer particles without prior use of an anionic activating agent (CE13) and with the anionic activating agent no. 6 without the use of cationic polymer particles (CE14), no increased corrosion protection resulted, although these comparison examples were again carried out with additional cleaning, pretreatment and coating with corrosion protection primer.

Examples El to E13 according to the invention were carried out in each case without additional cleaning, pretreatment and coating with corrosion protection primer. The metallic substrates, the activating agents and the polymer particle dispersions were varied here. In E12, the additional acid treatment was omitted, whereby a significantly poorer corrosion protection than in the comparable examples according to the invention resulted. This illustrates the importance of the additional charging. However, Examples E1 to E13 according to the invention have a significantly better corrosion protection than Comparison Examples CE5, CE6 and CE12.

Examples E14 to E27 according to the invention were carried out in each case with additional cleaning, pretreatment and coating with corrosion protection primer. The activating agents and the polymer particle dispersions were varied here, on the one hand cationic activating agents being employed with anionic polymer particle dispersions (E14 E25) and on the other hand anionic activating agents being employed with cationic polymer particle dispersions (E26, E27). A corrosion protection with respect to VDA white rust and VDA red rust of up to 6 and, respectively, 13 cycles was even achieved here. Based on the very thin layer thicknesses used here (approx. 0.08 to 0.3 μm in the examples), this is an increase and a level of corrosion protection rarely achieved in surface technology.

With respect to the lacquer adhesion, a significant influence of the polymer particle dispersion chosen and of the metallic substrate as to whether very high lacquer adhesion, as in E5 and E8, or a poor lacquer adhesion results, as in E7, manifests itself here.

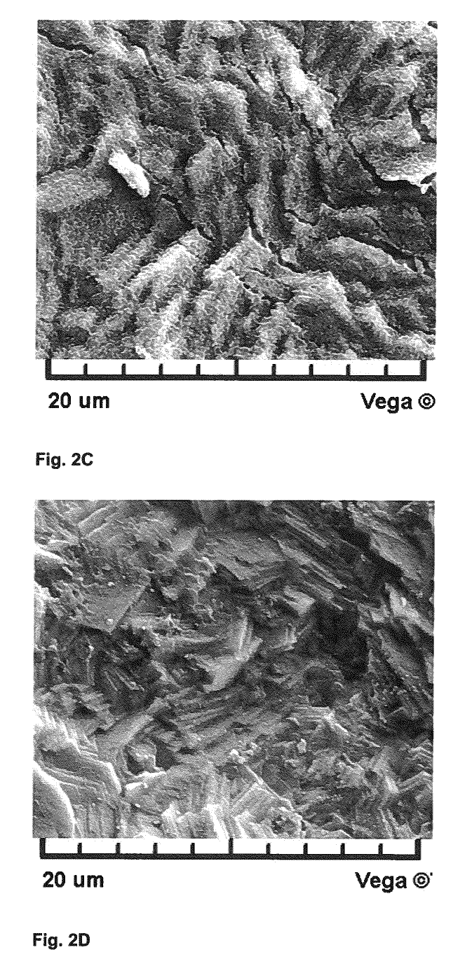

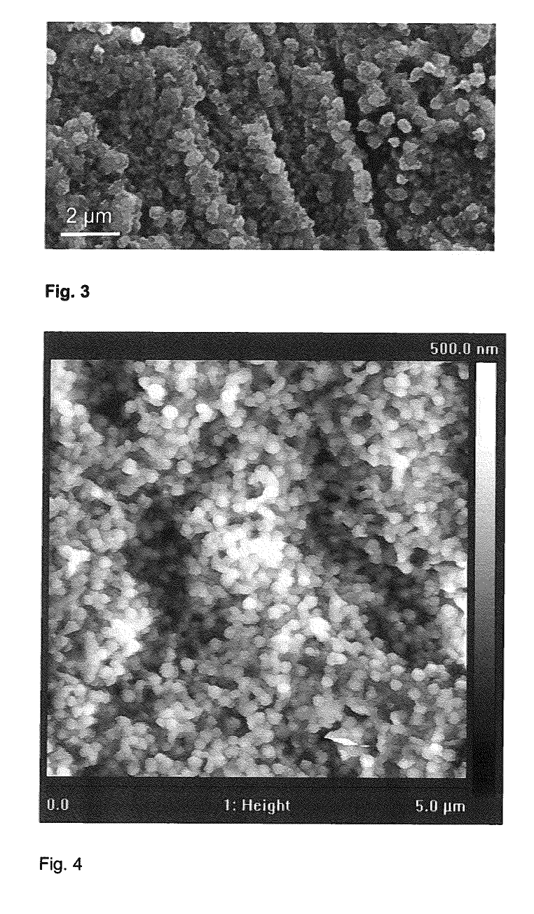

It has been found, surprisingly, that not only did the dispersions of organic polymer particles employed form a closed, largely homogeneous layer on the electrostatically charged surface, but this layer was also anchored to the surface in a wash-resistant manner. In contrast to this, after the washing operation the same dispersions which were applied without a corresponding electrostatic activation of the surface still showed significant gaps in the particle layer deposited (FIG. 3 in comparison with FIG. 4).

It is known that because of the lack of a barrier effect, thin coatings, for example with a layer thickness in the range of from 50 nm to 4 μm, are only of limited suitability for corrosion protection applications since the corrosion resistance is also a function of the layer thickness. However, since the organic polymeric coatings according to the invention which are formed from the organic particles can cover the edges and peaks of the substrate better than in the case of other production processes, and can be free from possibly troublesome constituents which could limit the corrosion resistance and are necessary for other application methods, such as e.g. electro-dip coating, for example because of the electrical conductivity, a comparatively higher corrosion protection—based on the same layer thicknesses—can also be achieved with the organic coatings produced according to the invention.

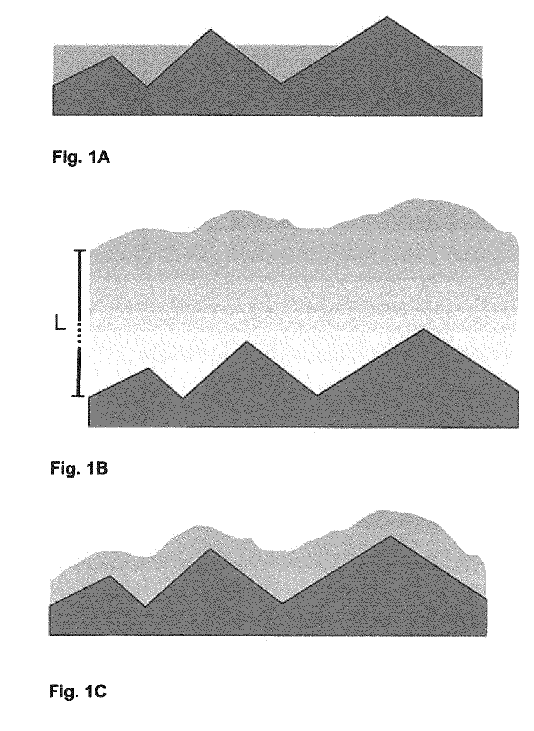

The reason for the considerable improvement in the corrosion protection lies in the homogeneous, thin coating which is produced from particles and which, in contrast e.g. to Comparison Example CE12, should have hardly any points of attack with respect to the corrosive medium (FIG. 4-FIG. 1C in contrast to FIG. 1A). In the case of conventional corrosion protection primer coatings which are applied by means of a doctor blade or application roller, defects such as are shown in FIG. 1A easily arise. The thin polymer coating according to the invention avoids such defects and thus prevents a direct corrosion attack on the substrate at incompletely covered places. Not only is the effect on white rust formation on galvanized substrates remarkable, but the coating according to the invention is capable of maintaining a corrosion protection on these surfaces for still a long time even after white rust formation, which considerably delays the red rust formation, so that up to 7 cycles can lie between white rust and red rust formation in the corrosion test, which is very unusual.

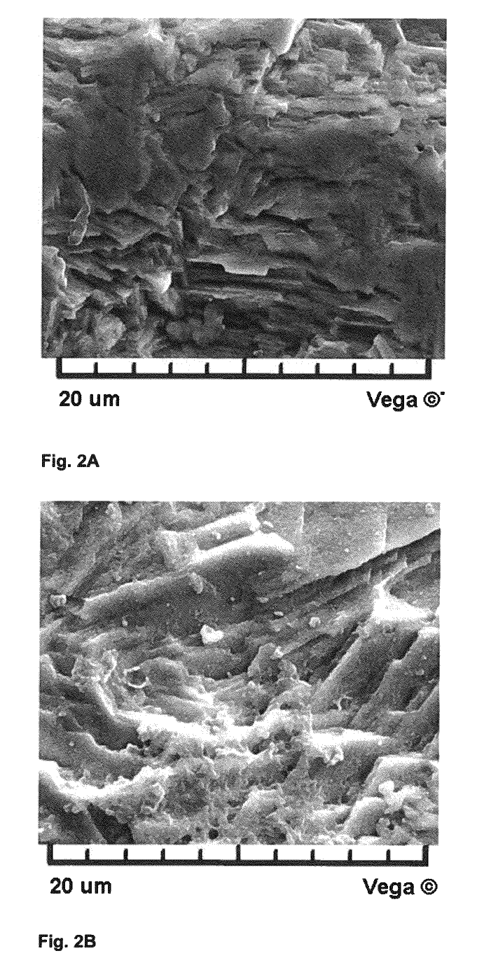

The high homogeneity of the coatings according to the invention can also be seen from the SEM and AFM photographs. FIG. 2A (CE1) shows a cleaned metal sheet on which the sharp edges of the crystalline zinc coating clearly stand out. In Examples E12 and E13, the pretreatment, the coating with a corrosion protection primer and the second alkaline cleaning were omitted. In the example of FIG. 2B (E12), in contrast to in E13, the acid treatment after the coating with activating agent was also omitted in order to emphasize the potent action of the additional positive charging for the process according to the invention. The sharp edges of the crystalline zinc coating, in addition to a large number of particles, can also be seen in FIG. 2B. It can be seen that from such particle layers it is possible to produce coatings which can be improved still further in their corrosion protection by additional positive charging before the particle coating. In contrast to this, the surface treated by the process according to the invention (FIG. 2D, E7) has a homogeneous coating which offers a particularly high corrosion protection in relation to the layer thickness.

In FIG. 3, the homogeneous particle covering before film formation becomes clear on the scanning force microscope photograph. It can be seen here that the particles have arranged themselves into a largely gap-free and dense packing both at the edges and in the depressions.

1-23. (canceled)

24. A process for the currentless coating of, in particular, metallic surfaces of objects, which can optionally be precoated, with a large number of at least one of inorganic water-insoluble particles or organic water-insoluble particles to form a substantially wash-resistant layer having a high particle density, in which the particles are applied to the surfaces to be coated in a stabilizable or stable aqueous composition in the form of a dispersion and are applied to and held on the surfaces to be coated substantially or predominantly by means of electrostatic forces, wherein
the surfaces to be coated are first activated with an activating agent, wherein an activation layer with charges is formed with the activating agent on the surfaces to be coated, wherein these charges are charged oppositely to the charges of the particles of the composition which are subsequently to be applied,
in that an activation layer is formed on the surface to be coated, which in the case of a cationic activation layer is produced by contacting with at least one cationic compound and which in the case of an anionic activation layer is produced by contacting with at least one anionic compound,
in that at least one protonatable or protonated silane or at least one protonatable or protonated nitrogen-containing compound is/are used as the cationic compound(s) or in that at least one deprotonatable compound or at least one deprotonated anion or at least one deprotonatable and/or deprotonated anionic compound is/are used as the anionic compound(s)
in that the particles applied in a coating step with a particle-containing composition are charged oppositely to the charges of the activation layer,
in that anionically stabilized aqueous polymer particle dispersions or cationically stabilized aqueous polymer particle dispersions are used as particles,
in that in a or in each coating step with a particle-containing composition in each case a layer is formed on the surfaces to be coated in an average thickness of several average particle sizes of the particles applied and the or each particle layer is optionally then formed into a film or crosslinked, as a result of which a layer thickness of the or each particle layer of particles which have not been formed into a film or of the coating which has been formed into a film or crosslinked produced therefrom in each case in the range of from 50 nm to 50 μm is achieved.

25. A process according to claim 24, wherein in the one or in each coating step with a particle-containing composition, regardless of the subsequent continuation of this coating step, in each case a layer is formed on the surfaces to be coated in an average thickness of approximately one or more average particle sizes of the particles applied.

26. A process according to claim 24, wherein the particles applied electrostatically in the case of at least a second electrostatic coating step with a particle-containing composition are charged oppositely to the charges of the particular previously applied layer of particles.

27. A process according to claim 24, wherein several particle layers are formed on top of one another from particle-containing compositions, these layers being built up preferably alternately from particles which are positively charged with protons or cations and from particles which are negatively charged with anions.

28. A process according to claim 24, wherein a substantially wash-resistant activation layer is formed.

29. A process according to claim 24, wherein washing of the activation layer or of the particle layer is carried out with a flowing or in a streaming aqueous wash liquid.

30. A process according to claim 24, wherein the activation layer is positively charged with protons or cations and in that the first particle layer of a particle-containing composition applied thereto is correspondingly negatively charged with anions or with at least one anionic compound—or vice versa.

31. A process according to claim 24, wherein the activation layer or the particles of the last particle layer are charged with a positively or negatively charged liquid or with positive or negative electrical charges of a gas or in vacuo.

32. A process according to claim 24, wherein the charged activation layer or the charged particles of the last particle layer comes/come into contact with at least one correspondingly charged substance, which leads to an even stronger positive or negative charge.

33. A process according to claim 24, wherein the positive charging of the activation layer or of particles of the particle layer is effected by treatment with at least one acid or with at least one substance which carries cationic groups, or in that negative charging of an activation layer or of particles of the particle layer is effected by treatment with at least one anion or with at least one substance which carries anionic groups.

34. A process according to claim 24, wherein the activation of the cationic activation layer or of particles of the particle layer is effected with at least one cationic silicon compound or the positive charging of the activation layer or of particles of the particle layer is effected by treatment with at least one acid or with cationic groups.

35. A process according to claim 24, wherein the activation of the anionic activation layer or of particles of the particle layer is effected with at least one anionic compound or the negative charging of the activation layer or of particles of the particle layer is effected by treatment with at least one anion or with at least one anionic compound.

36. A process according to claim 24, wherein the composition has a zeta potential in the range of from −200 to +200 mV.

37. A process according to claim 24, wherein organic polymers, in particular based on epoxide, ethylene acrylate, alkyl (meth)acrylate, polyethylene, polyisobutylene, polyacrylonitrile, polyvinyl chloride, poly(meth)acrylate, polyalkyl (meth)acrylate, such as e.g. polymethyl methacrylate, polyvinyl acetate, polyvinyl alcohol, polyvinylidene chloride, polytetrafluoroethylene, polyisoprene, polypropylene, poly(meth)acrylate, polyester, polyether, aminoplast, polyurethane, phenolic resin, alkyd resin, polycarbonate, polyamide, polystyrene, polysulfide, polysiloxane, polyvinyl acetate, polyacetal, styrene acrylate, derivatives thereof, compoundings thereof or mixtures thereof, are used as particles in the particle-containing composition, in the particle layer or in the coating formed therefrom.

38. A process according to claim 24, wherein the particle layer formed is washed with a wash liquid and is thereafter coated with at least one of an organic composition of a primer or lacquer or with further particles of opposite charge to the particles of the previously applied particle layer.

39. A process according to claim 24, wherein a particle layer containing organic particles is formed and is then formed into a film or crosslinked.

40. A process according to claim 24, wherein the particle-containing composition, the particle layer formed therefrom or the coating formed therefrom, further comprises a member selected from the group consisting of dyestuff, a colored pigment, a corrosion protection pigment, a corrosion inhibitor, a conductivity pigment, a further particles, a silane, a silanol, a siloxane, a polysiloxane, a silazane, a polysilazane, a lacquer additive, a surfactant, a defoamer and a dispersing agent.

41. A process according to claim 24, wherein the composition or the coating formed therefrom contains, in addition to at least one type of particles and optionally in addition to at least one non-particulate substance, part of or a complete chemical composition for a primer or a lacquer.

42. A coating produced by the process according to claim 24.

43. A coated substrate coated according to the process of claim 24, wherein the coated is substrate wire, braided wire, belt, metal sheet, profile, lining, part of a vehicle or aircraft, element for a domestic appliance, element in building construction, stand, element of a crash barrier, radiator or fence, a screw, a nut, a flange or a spring.

44. A process according to claim 25, wherein the particles applied electrostatically in the case of at least a second electrostatic coating step with a particle-containing composition are charged oppositely to the charges of the particular previously applied layer of particles.
